(19) United States
(12) Patent Application Publication
(10) Pub. No.: US 2023/0060712 A1
(43) Pub. Date: Mar. 2, 2023

(54) DETERMINING AN ERROR IN APPLICATION OF PRINT AGENT

(71) Applicant: Hewlett-Packard Development Company, L.P., Spring, TX (US)

(72) Inventors: Pol Fornos Martinez, Sant Cugat del Valles (ES); Xavier Espert Canet, Sant Cugat del Valles (ES); Ismael Fernandez Aymerich, Sant Cugat del Valles (ES); Roger Fadurdo Orellana, Sant Cugat del Valles (ES); Pol llopat Mirambell, Sant Cugat del Valles (ES); Marc Borras Camarasa, Sant Cugat del Valles (ES); Alejandro Manuel de Pena Hempel, Sant Cugat del Valles (ES); Pablo Dominguez Pastor, Sant Cugat del Valles (ES)

(21) Appl. No.: 17/758,092

(22) PCT Filed: Jan. 31, 2020
(86) PCT No.: PCT/US2020/016134

§ 371 Date: Jun. 28, 2022

(51) Int. Cl. B29C 64/393; B29C 64/165

(52) U.S. Cl. CPC B29C 64/393; B29C 64/165; B33Y 50/02

(57) ABSTRACT

A 3D printer is controlled to apply a print agent at a plurality of predetermined locations in a build chamber of the 3D printer, and energy is applied to heat the build chamber. A thermal image of the build chamber is received. Based on the thermal image, an error in application of the print agent in the build chamber is determined.

### BACKGROUND

A three-dimensional (3D) printer may generate a 3D object in a build chamber by forming a plurality of successive layers of a powdered or granular build material and selectively solidifying portions of each layer. In one technique each formed layer may have an energy absorbing fusing agent selectively applied to locations within the layer, based on a received 3D object model. Energy is then applied generally to the whole layer, and those portions of the layer where fusing agent was applied heat up sufficiently to melt and fuse to form, upon cooling and solidification, a layer of the object being generated. In some techniques, each formed layer may also have a detailing agent selectively applied to locations within the layer, wherein the detailing agent modifies the effects of the fusing agent, for example by reducing or increasing coalescence of the powder by, for example, cooling the build material.

### BRIEF DESCRIPTION OF DRAWINGS

FIG. 1 is a schematic block diagram of an example 3D printer;

FIG. 2 is a flowchart of an example method of determining an error in application of print agent;

FIG. 3 is a flowchart of an example method of determining an error in the application of detailing agent;

FIG. 4 is a flowchart of an example method of determining an error in the application of print agent during a print job;

FIG. 5 is a flowchart of an example method of determining whether to continue printing in the event of an error during a print job; and

FIG. 6 is a schematic block diagram of an example computer-readable storage medium.

### DETAILED DESCRIPTION

Examples of the present disclosure relate to a method comprising controlling a 3D printer to apply a print agent at a plurality of predetermined locations on a layer of build material in a build chamber of the 3D printer, and applying energy to the formed layer. The method may further include receiving a thermal image of the formed layer, and determining, based on the thermal image, an error in application of the print agent in the build chamber.

The print agent may be a fusing agent. The fusing agent may have a composition that absorbs energy such that, when energy is applied to the build chamber, the build material on which fusing agent is applied heats up, coalesces and solidifies upon cooling, to form a layer of a three-dimensional object, whereas build material on which no fusing agent is applied does not heat up sufficiently to coalesce. A further print agent may be a detailing agent, which may act to modify the effects of a fusing agent for example by reducing or increasing coalescence or to assist in producing a particular finish or appearance to an object. In some examples, detailing agent may be a print agent used near edge surfaces of an object being printed to reduce or prevent coalescence by, for example, cooling the build material or through some other mechanism.

In one example, the error in application of the print agent is cross-contamination of the detailing agent with the fusing agent. This may for example occur due to cleanliness problems of a printhead used to apply the fusing agent and detailing agent. For example, the fusing agent and detailing agent may be applied by different rows of nozzles on the same printhead. Accordingly, contamination may occur if fusing agent inadvertently comes into contact with the of the nozzles that apply the detailing agent. In some circumstances, a detailing agent nozzle may suck up an amount of fusing agent. In some circumstances, wiping of a detailing agent nozzle may introduce fusing agent into the detailing agent nozzle. In other examples, dried print agent in a nozzle may contribute to cross contamination. These circumstances may be referred to external cross-contamination, wherein external factors have caused introduction of fusing agent to the detailing agent supply. In other examples, the cross-contamination may be internal cross-contamination caused by an internal failure in the print unit. For example, a part separating the detailing agent and fusing agent in the print unit may fail, for example due to a manufacturing error or due to excessive exposure of the part to heat over a long time. These situations can lead to cross-contamination of the detailing agent with the fusing agent, and associated print errors.

In one example, the error in application of the print agent is a mismatch between an intended location of the print agent and an actual location of the print agent. This may for example include a failure to apply the print agent in the intended location, or application of the print agent to unintended locations.

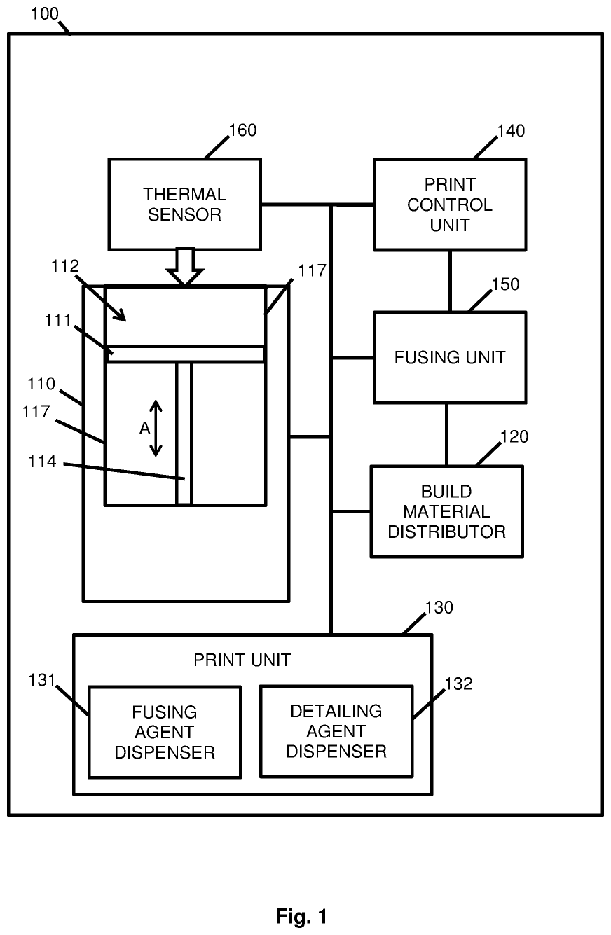

FIG. 1 shows an example 3D printer 100. The 3D printer 100 may be used to form a 3D object.

The 3D printer 100 comprises a build material distributor 120, a print unit 130, a print control unit 140, a fusing unit 150, and a thermal sensor 160. The 3D printer 100 is also to receive a build unit 110. The build unit 110, which is shown in schematic cross-section in FIG. 1, may be a modular unit insertable into the 3D printer 100. However, in other examples, the build unit 110 may be integral to the 3D printer 100.

The build unit 110 comprises a build chamber, generally indicated by the reference number 112, in which the formation of a 3D object takes place. In one example, the build chamber 112 is a substantially cuboid volume defined in the interior of the build unit 110.

The build chamber 112 comprises a movable build platform 111, which may be movable in a substantially vertical direction, as indicated by arrow A. The movable platform 111 may support a plurality of layers of build material within which the 3D object is produced. The moveable platform 111 forms a bottom of the build chamber 112 and is sealed around its edges to the sidewalls 117.

The build unit 110 may comprise an actuation mechanism 114 to translate the platform. In one example, the actuation mechanism comprises a drive screw. In further examples, the actuation mechanism 14 may comprise a scissor jack, a piston or any other suitable actuator.

The build material distributor 120 delivers build material to the build chamber 112. The build material distributor 120 may be to deliver a layer of build material to the build chamber 112. For example, the build material distributor 120 may comprise a movable carriage to move over the build chamber 112 in a substantially horizontal direction whilst distributing the build material in a uniform layer. The movable carriage may also comprise a recoater, such as a roller or a blade, to smooth the surface of the build material after it is deposited.

The print unit 130 is to selectively apply print agent to locations of a layer of the build material. The print unit 130 may comprise a fusing agent dispenser 131, to selectively apply fusing agent to a plurality of fusing agent locations. The fusing agent locations may define which portions of the layer of the build material should be solidified to form a layer of the 3D object. In some examples, the print unit 130 may also comprise a detailing agent dispenser 132, to selectively apply detailing agent to a plurality of detailing agent locations.

The fusing unit 150 is to apply energy to a layer of build material. This causes heating of the build material in the location of the fusing agent, so as to cause the material to heat up and coalesce. Upon cooling, the build material forms a layer of the 3D object. The energy may be heat energy. In some examples, the fusing unit 150 may cause evaporation of the detailing agent.

The thermal sensor 160 is to capture a thermal image of the build chamber 112. In one example, the thermal sensor 160 is positioned to capture a plan view image of the build chamber 112. Accordingly, the thermal sensor 160 may capture a plan view image of an uppermost layer of the build material in the build chamber 112. For example, the thermal sensor 160 may be disposed in the 3D printer 100 such that it points downwardly into the build chamber 112, for example as indicated by the arrow in FIG. 1. Accordingly, the captured thermal image may comprise a 2D array of pixels, wherein the pixel value of each pixel represents the temperature of a corresponding pixel location in the build chamber.

In one example, the thermal sensor 160 is a thermopile sensor, for example a thermopile sensor sold under the brand name Heimann®. In other examples, other suitable sensors may be used to determine the temperature of locations in the build chamber 112 and provide a thermal image.

The print control unit 140, which may comprise a processor and a memory, is to control the build material distributor 120, print unit 130 and fusing unit 150 in order to generate the 3D object. In addition, the print control unit 140 may be to control the build unit 10. In one example, the print control unit 140 is to generate the 3D object based on a received 3D object model comprising a model of the 3D object.

The print control unit 140 may control the thermal sensor 160 to capture a thermal image of the build chamber 112. The print control unit 140 may control the thermal sensor 160 to capture an image after energy has been applied by the fusing unit 150. Furthermore, the print control unit 140 may be to determine an error in the application of print agent by the print unit 130, based on the captured thermal image, as will be discussed in more detail below.

In general use, the print control unit 140 controls the build material distributor 120, print unit 130 and fusing unit 150 to deliver a layer of build material to the build chamber 112, apply print agent to the layer of build material, and then apply energy to form a layer of the 3D object. The platform 111 is then lowered, for example by the depth of a layer, and the process is then repeated until all desired layers have been formed.

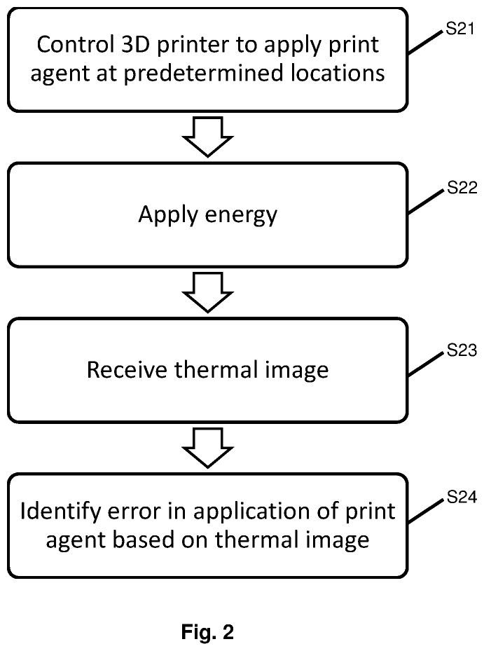

FIG. 2 illustrates an example method of determining an error in application of a print agent.

In block S21, the 3D printer 100 is controlled to apply a print agent at a plurality of predetermined locations in the build chamber 112, for example using the print unit 130. In block S22, the 3D printer 100 is controlled to apply energy to the build chamber 112, for example using the fusing unit 150. In block S23, a thermal image of the build chamber 112 is received. For example, the thermal sensor 160 may be used to capture the thermal image. In block S24, an error in application of the print agent in the build chamber is identified, based on the thermal image.

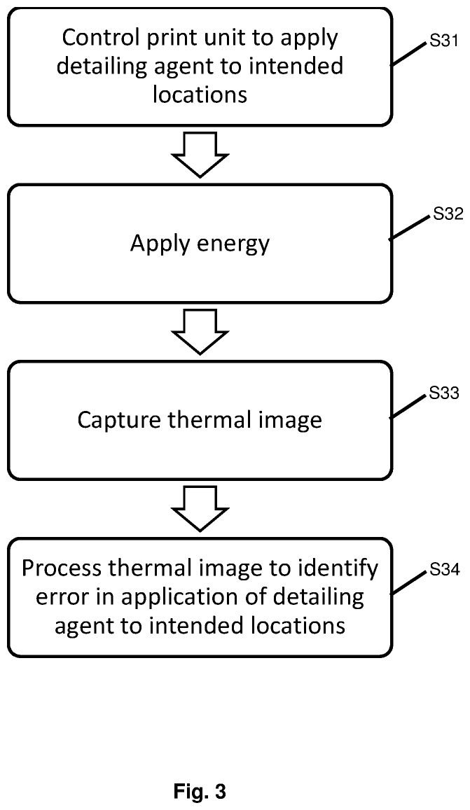

FIG. 3 illustrates an example method of determining an error in application of a print agent in more detail.

In block S31, the print control unit 140 controls the print unit 130 to apply detailing agent to a plurality of intended locations in the build chamber 112. The intended locations are locations where the agent should be deposited if no error occurs in the application of the print agent.

For example, the print control unit 140 may control the print unit 130 to apply the detailing agent in a plurality of patches or regions. The patches may form part of a pattern, particularly a calibration pattern. This may form part of a calibration procedure performed at the beginning of a print job, in order to calibrate the thermal sensor 160 in order to account for lens distortion. In one example, the build chamber 140, particularly a layer of powder formed therein may be preheated to a predetermined temperature before application of the detailing agent. The predetermined temperature may be referred to as a background temperature. The predetermined temperature may be varied depending upon the type of the build material employed.

In block S32, energy is applied to the build chamber 112, for example by the fusing unit 150.

In block S33, a thermal image of the build chamber 112 is captured, for example using the thermal camera 160.

In block S34, the thermal image is processed, to determine if there has been an error in the application of the detailing agent to the plurality of intended locations.

In more detail, the application of detailing agent to the build chamber 112 will cause a cooling of the print chamber in the locations in a predictable manner. For example, if the bed of the build chamber 112 is maintained at a temperature of 160° C., the detailing agent may cause a decrease in temperature of 10-15° C. In contrast, the presence of fusing agent in the build chamber 112 will cause an increase in the temperature of the chamber 112 at locations where the fusing agent is present.

In one example, an average temperature (e.g. a mean temperature) of the build chamber 112 may be calculated from the captured thermal image. This calculated average temperature may then be compared to an expected average temperature, which may be an average temperature that would be expected if the chamber 112 was cooled by the deposit of detailing agent. If the calculated average temperature exceeds the expected average temperature by a predetermined amount, it can be determined that fusing agent is also present in the build chamber 112. This may be indicative of cross-contamination of the detailing agent with fusing agent, due to an error in the print unit 130.

In another example, the thermal image is processed to determine the temperature of locations in the thermal image corresponding to the intended locations of detailing agent application. If the measured temperature of any of the locations exceeds an expected temperature of the location by a predetermined amount, then this may be indicative of the presence of fusing agent in that location, which in turn may also indicate cross contamination of the detailing agent with the fusing agent.

In a further example, the measured temperature of the location may be used to determine that no detailing agent has been applied in an intended location, for example because a nozzle of a print head of the detailing agent dispenser 132 is obstructed. In other words, it may be determined that an intended location of the detailing agent is not amongst the determined locations of the detailing agent in the thermal image.

For example, the application of uncontaminated detailing agent may correspond to first range of expected temperatures, the application of detailing agent contaminated with fusing agent may correspond to a second range of expected temperatures, and a failure to apply detailing agent may correspond to a third range of expected temperatures. Accordingly, the measured temperature in the thermal image at a location corresponding to a location where the application of detailing agent is intended allows the determination of an error in application of the detailing agent.

In some examples, the measured temperature in a particular location or the average measured temperature in the image as a whole may be determined over a predetermined time period. Accordingly, a plurality of captured thermal images may be processed to determine an average (e.g. mean) of the temperature over the predetermined time period. This average value for the time period may be then compared to the expected temperatures as discussed above.

As discussed above, the determination of an error in the application of the detailing agent may be carried out before commencing a print job. Accordingly, in the event that an error is detected in the application of detailing agent, the 3D printer 100 may not commence the print job, and may carry out appropriate remedial action.

In one example, the print control unit 140 may initiate a cleaning routine, which for example cleans the detailing agent dispenser 132 and in particular the print heads or nozzles thereof. This may be a purging routine, which purges potentially contaminated detailing agent in the nozzles. The purging routine may comprise controlling the detailing agent dispenser 132 to feed a volume of detailing agent through the nozzles. This may rid the nozzles of any fusing agent that has been introduced into the detailing agent nozzles. The purging routine may also dislodge any blockages, including partial blockages, caused by dried print agent or powder. Upon completion of the cleaning routine, the process of FIG. 3 may be repeated to ascertain whether cross-contamination or nozzle obstruction is still present. In the event that the cleaning routine does not correct the error, for example because it is due to internal cross-contamination, the print control unit 140 may not commence the printing of the print job.

In one example, the print control unit 140 may identify which nozzle of the detailing agent dispenser 132 is obstructed. Particularly, the memory of the print control unit 140 may maintain a record of which nozzle was assigned to apply detailing agent at each intended location of application. Accordingly, if it is determined that detailing agent is not present at the location, it the associated nozzle may be identified. In one example, this may be conveyed to a user, for example as an error message displayed on user interface of the 3D printer 100 or sent to a computing device connected to the 3D printer.

In another example, the print unit 130 may be controlled to deposit fusing agent at a plurality of intended locations in the build chamber 112, in a manner substantially corresponding to the application of detailing agent described above. If a location in a captured thermal image does not display an expected increase in temperature, it may be indicative of an obstruction in a nozzle of the fusing agent dispenser 131. Similar remedial action may be undertaken, including identifying the nozzle that is obstructed, or undertaking a cleaning routine to purge the fusing agent dispenser 131.

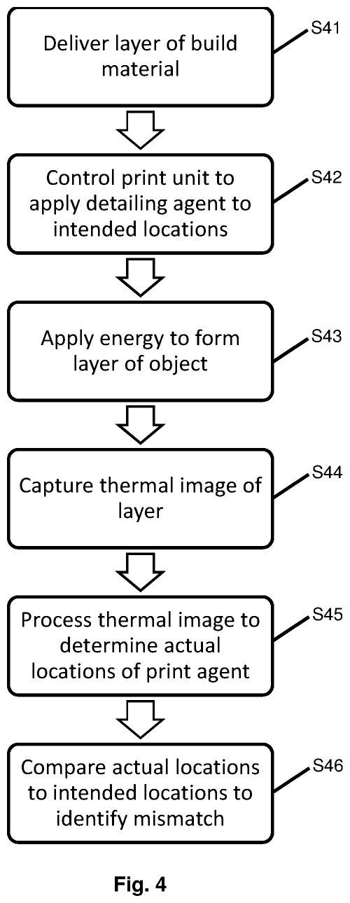

FIG. 4 illustrates another example method of determining an error in application of a print agent.

In block S41, the print control unit 140 controls the build material distributor 120 to deliver a layer of build material to the build chamber 112.

In block S42, the print control unit 140 controls the print unit 130 to apply print agent to the layer of build material in a plurality of intended print agent locations. The intended print agent locations be based on location data corresponding to a layer of a 3D object, derived from 3D object model data representing the geometry of the 3D object. The 3D object model data may be comprise an STL file, 3MF file or the like.

In block S43, the print control unit 140 controls the fusing unit to apply energy to form the layer of the 3D object.

In block S44, a thermal image of the build chamber 112 is captured, showing the layer of the 3D object that was previously formed by the 3D printer 100.

In block S45, the thermal image is processed to determine the actual locations at which the print agent was applied. For example, as discussed above, application of fusing agent in a location in the layer may cause an increased temperature in that location. The temperature may be increased in relation to an expected temperature in the event no fusing agent is applied, which may also be referred to as a background temperature of the build chamber 110. Accordingly, actual locations of fusing agent in the image may be determined by identifying locations of increased temperature.

In block S46, the actual locations of the print agent are compared to the intended locations of the print agent. If the actual locations of the print agent are not in agreement with the intended locations of the print agent, it may be indicative of an error in the application of the print agent.

In more detail, there may be mis-match between the intended and actual locations of the print agent if print agent is not actually applied to some of, or any of, the intended locations. This may for example be due to an obstruction in a nozzle of a printhead of the print unit 130 as discussed herein.

In addition, there may also be a mis-match between the intended and actual locations of the print agent if the actual locations include locations not present in the intended locations. In other words, print agent is applied to a location other than the intended location. This may be indicative in a failure of the print unit 130, for example a die or print head of the print unit 130, which causes inadvertent application of the print agent.

In one example, in the event of a mis-match between the intended and actual locations of the print agent, the print control unit 140 may control the 3D printer 100 to discontinue the print job. In other words, the 3D printer 100 will not go on to form the subsequent layers of the 3D object.

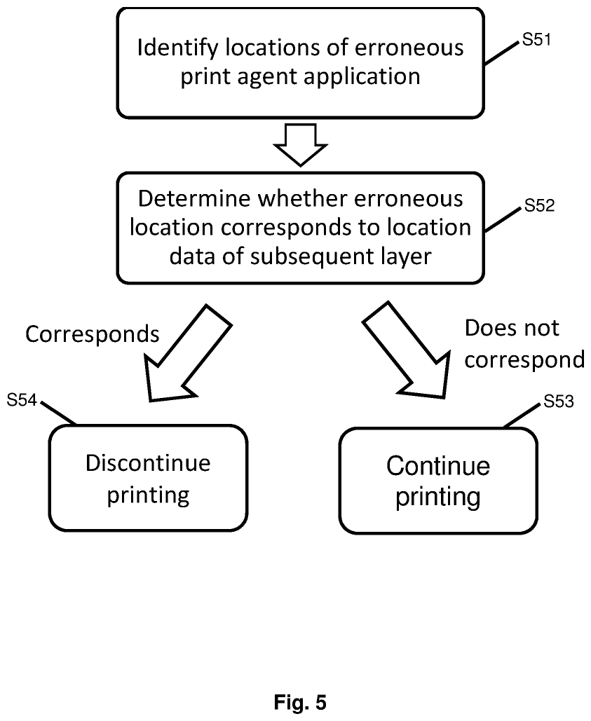

FIG. 5 shows a further example method, in which the print control unit 140 may determine if it is appropriate for the 3D printer 100 to continue printing despite the identification of the error in the application of the print agent.

In block S51, locations of erroneous print agent application are identified based on the intended and actual locations of the print agent. Particularly, the locations of erroneous print agent application may be those regions where either: print agent has been applied but should not have been applied, or print agent has not been applied but should have been applied.

In block S52, it is determined whether a location of the identified erroneous print agent application corresponds to location data representing a subsequent layer of the 3D object. In other words, it is determined whether the erroneous locations are locations where print agent will be applied in any of the subsequent layers of the object.

In block S53, in the event that the location of the identified erroneous print agent application does not correspond to the location data of a subsequent layer of the 3D object, printing of the object is continued. This is because, whilst a failure has occurred, the failure does not overlap with the 3D object to be printed, and therefore the job can be continued.

In block S54, in the event that the location of the identified erroneous print agent application does correspond to the printing agent location data of a subsequent layer of the 3D object, printing of the 3D object is discontinued.

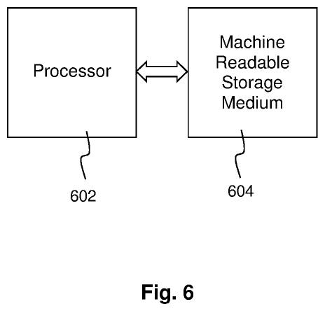

FIG. 6 shows an example non-transitory machine-readable storage medium 604 encoded with instructions executable by a processor 602.

The machine-readable storage medium 604 may comprise instructions to determine locations of a print agent in a thermal image of a build chamber of a 3D printer. The machine-readable storage medium 604 may comprise instructions to identify an error condition in the 3D printer based on the determined locations of the print agent in the thermal image. The error condition may be cross-contamination of detailing agent and fusing agent, a failure to apply a print agent, or application of a print agent to a location other than a desired location, as discussed herein.

The examples described herein permit the identification of errors in the application of print agent, which may for example be caused by faults or failures in the print unit. The errors may be identified prior to embarking on a print job, as part of a calibration procedure that would be carried out before each job. Alternatively, the errors may be identified during a printing, soon after the error has occurred.

1. A method comprising:
controlling a 3D printer to apply a print agent at a plurality of predetermined locations on a layer of build material formed in a build chamber of the 3D printer;
applying energy to the formed layer;
receiving a thermal image of the formed layer;
determining, based on the thermal image, an error in application of the print agent on the formed layer.

2. The method of claim 1, comprising:
controlling the 3D printer to apply a detailing agent at predetermined locations on the formed layer, and
determining cross-contamination of the detailing agent with a fusing agent based on the thermal image.

3. The method of claim 2, comprising:
determining an average temperature of the thermal image, and
determining cross-contamination of the detailing agent with fusing agent in response to the average temperature of the image exceeding an expected temperature of the formed layer by a predetermined amount.

4. The method of claim 2, comprising:
controlling the 3D printer to apply a calibration patch comprising the detailing agent during a calibration procedure of a thermal sensor capturing the thermal image.

5. The method of claim 2, comprising initiating a cleaning procedure of a printhead of the 3D printer in response to determining that cross-contamination of the detailing agent with the fusing agent has occurred.

6. The method of claim 1, comprising:
processing the thermal image to identity actual print agent locations where print agent has been applied;
identifying the error in application of the print agent in response to a mismatch between the actual print agent locations and print agent location data, the print agent location data representing locations on the formed layer where application of print agent was intended.

7. The method of claim 6, wherein the print agent location data is image data corresponding to a layer of an object printed by the 3D printer.

8. A 3D printer comprising;
a build material distributor to distribute a layer of build material to a build chamber in which an object may be formed;
a print unit to selectively apply a print agent to the formed layer in a plurality of intended print agent locations;
a fusing unit to apply heat energy to the formed layer;
a thermal sensor to capture a thermal image of the formed layer;
a processor to:
process the thermal image to determine a plurality of actual locations at which print agent has been applied, and
determine an error condition in the print unit in response to the actual locations of the print agent not corresponding to the intended print agent locations.

9. The 3D printer of claim 8, wherein:
the print unit is to selectively apply a detailing agent to the layer in a plurality of intended detailing agent locations;
the processor is to determine the actual locations of a fusing agent in the thermal image; and
the processor is to determine, in response to one of the plurality of actual locations of the fusing agent corresponding to one of the intended detailing agent locations, that the error condition is cross-contamination of the detailing agent with the fusing agent.

10. The 3D printer of claim 9, wherein:
the processor is to control the print unit to apply the detailing agent to the build chamber before beginning a print job;
wherein, in response to the processor determining cross-contamination of the detailing agent with the fusing agent, the processor is to discontinue the print job.

11. The 3D printer of claim 8, wherein the thermal sensor is disposed above the build chamber to capture a plan view image of the layer.

12. A non-transitory machine-readable storage medium encoded with instructions executable by a processor, the storage medium comprising:
instructions to determine locations of a print agent in a thermal image of a build chamber of a 3D printer; and
instructions to identify an error condition in the 3D printer based on the determined locations of the print agent in the thermal image.

13. The storage medium of claim 12, comprising:
instructions to identify erroneous print agent application in response to a mismatch between a plurality of determined locations of fusing agent and fusing agent location data representing a plurality of intended locations of fusing agent.

14. The storage medium of claim 13, wherein the print agent location data is print agent location data representing a first layer of print job to be printed by the 3D printer;
the storage medium further comprises instructions to determine whether a location of the identified erroneous print agent application corresponds to second print agent location data representing a subsequent layer of the print job,
instructions to continue print the print job in response to determining that the location of the identified erroneous print agent application does not correspond to the second print agent location data; and
instructions to discontinue printing of the print job in response to determining that the location of the identified erroneous print agent application corresponds to the second print agent location data.

15. The storage medium of claim 12, comprising
instructions to control the 3D printer to apply a print agent to an intended print agent location in the build chamber; and
instructions to identify an obstruction in a nozzle of 3D printer in response to the determined locations of the print agent not comprising the intended print agent location.
